(19) United States
(12) Patent Application Publication
(10) Pub. No.: US 2024/0069209 A1
(43) Pub. Date: Feb. 29, 2024

(54) SYSTEMS AND METHODS FOR SMOOTHING GNSS DATA

(71) Applicant: Samsung Electronics Co., Ltd., Suwon-si (KR)

(72) Inventors: Raul H. ETKIN, Sunnyvale, CA (US); Makarand S. PHATAK, San Jose, CA (US)

(21) Appl. No.: 18/163,228

(22) Filed: Feb. 1, 2023

Related U.S. Application Data
(60) Provisional application No. 63/400,372, filed on Aug. 23, 2022.

(51) Int. Cl. G01S 19/25; G01S 19/48

(52) U.S. Cl. CPC G01S 19/252; G01S 19/48

(57) ABSTRACT

A system and a method are disclosed for smoothing Global Navigation Satellite System (GNSS) data. In some embodiments, the method includes receiving a first estimate from a navigation engine of a Global Navigation Satellite System (GNSS) receiver, and processing the first estimate with a first Kalman smoother.

### CROSS-REFERENCE TO RELATED APPLICATION

This application claims the priority benefit under 35 U.S.C. § 119(e) of U.S. Provisional Application No. 63/400,372, filed Aug. 23, 2022, the disclosure of which is incorporated by reference in its entirety as if fully set forth herein.

### TECHNICAL FIELD

The disclosure generally relates to position and velocity estimation. More particularly, the subject matter disclosed herein relates to improvements to systems and methods for smoothing Global Navigation Satellite System (GNSS) data.

### SUMMARY

Poor performance of a Global Navigation Satellite System receiver in a mobile device (e.g., a mobile telephone or a watch) may result in an unfavorable user experience. To solve this problem, various metrics of performance are used to evaluate Global Navigation Satellite System receivers.

One such metric is position errors (e.g., two-dimensional errors), which requires knowledge of the true position via, e.g., an IMU. When the true position is not available, other metrics are required. Sometimes, the performance is evaluated by identifying spec-outs, which are excursions outside a pre-determined boundary, configured for each test route. In other cases, the performance is evaluated qualitatively by the smoothness of the path as seen on a map. As such, a design, for a Global Navigation Satellite System receiver, that is targeted to improving position error performance, may not achieve good ratings in an evaluation system based, for example, on spec-outs or smoothness of the path.

To overcome these issues, systems and methods are described herein for providing improved performance as measured by smoothness-based criteria and the absence of spec-outs. The above approaches improve on previous methods because they provide fewer spec-outs and smoother paths as published by the Global Navigation Satellite System receiver.

According to an embodiment of the present disclosure, there is provided a method, including: receiving a first estimate from a navigation engine of a Global Navigation Satellite System (GNSS) receiver; and processing the first estimate with a first Kalman smoother.

In some embodiments, the first estimate is a position estimate.

In some embodiments, the first Kalman smoother includes a latitude Kalman smoother and a longitude Kalman smoother.

In some embodiments, the method further includes calculating a process noise covariance for the longitude Kalman smoother, based on an estimated latitude.

In some embodiments, the method further includes calculating a measurement noise covariance for the longitude Kalman smoother, based on an estimated latitude.

In some embodiments, the method further includes, during a warmup interval: processing a plurality of estimates from the navigation engine, including the first estimate, with the first Kalman smoother; and publishing the estimates from the navigation engine.

In some embodiments, the method further includes, during a transition-to-on interval: processing a plurality of estimates from the navigation engine with the first Kalman smoother, to generate a plurality of smoothed estimates; publishing, at a first point in time in the transition-to-on interval, a first weighted average, of a first one of the estimates from the navigation engine and a first one of the smoothed estimates; and publishing, at a second point in time, later than the first point in time, in the transition-to-on interval, a second weighted average, of a second one of the estimates from the navigation engine and a second one of the smoothed estimates, the proportion of the smoothed estimate in the second weighted average being greater than the proportion of the smoothed estimate in the first weighted average.

In some embodiments, the method further includes, during an on interval: processing a plurality of estimates from the navigation engine with the first Kalman smoother, to generate a plurality of smoothed estimates; and publishing the smoothed estimates.

In some embodiments, the method further includes, during a transition-to-off interval: processing a plurality of estimates from the navigation engine with the first Kalman smoother, to generate a plurality of smoothed estimates; publishing, at a first point in time in the transition-to-on interval, a first weighted average, of a first one of the estimates from the navigation engine and a first one of the smoothed estimates; and publishing, at a second point in time, later than the first point in time, in the transition-to-on interval, a second weighted average, of a second one of the estimates from the navigation engine and a second one of the smoothed estimates, the proportion of the smoothed estimate in the second weighted average being less than the proportion of the smoothed estimate in the first weighted average.

According to an embodiment of the present disclosure, there is provided a Global Navigation Satellite System receiver, including: one or more processors; and a memory storing instructions which, when executed by the one or more processors, cause performance of: receiving a first estimate from a navigation engine of the Global Navigation Satellite System receiver; and processing the first estimate with a first Kalman smoother.

In some embodiments, the first estimate is a position estimate.

In some embodiments, the first Kalman smoother includes a latitude Kalman smoother and a longitude Kalman smoother.

In some embodiments, the instructions, when executed by the one or more processors, further cause performance of: calculating a process noise covariance for the longitude Kalman smoother, based on an estimated latitude.

In some embodiments, the instructions, when executed by the one or more processors, further cause performance of: calculating a measurement noise covariance for the longitude Kalman smoother, based on an estimated latitude.

In some embodiments, the instructions, when executed by the one or more processors, further cause performance, during a warmup interval, of: processing a plurality of estimates from the navigation engine, including the first estimate, with the first Kalman smoother; and publishing the estimates from the navigation engine.

In some embodiments, the instructions, when executed by the one or more processors, further cause performance, during a transition-to-on interval, of: processing a plurality of estimates from the navigation engine with the first Kalman smoother, to generate a plurality of smoothed estimates; publishing, at a first point in time in the transition-to-on interval, a first weighted average, of a first one of the estimates from the navigation engine and a first one of the smoothed estimates; and publishing, at a second point in time, later than the first point in time, in the transition-to-on interval, a second weighted average, of a second one of the estimates from the navigation engine and a second one of the smoothed estimates, the proportion of the smoothed estimate in the second weighted average being greater than the proportion of the smoothed estimate in the first weighted average.

In some embodiments, the instructions, when executed by the one or more processors, further cause performance, during an on interval, of: processing a plurality of estimates from the navigation engine with the first Kalman smoother, to generate a plurality of smoothed estimates; and publishing the smoothed estimates.

In some embodiments, the instructions, when executed by the one or more processors, further cause performance, during a transition-to-off interval, of: processing a plurality of estimates from the navigation engine with the first Kalman smoother, to generate a plurality of smoothed estimates; publishing, at a first point in time in the transition-to-on interval, a first weighted average, of a first one of the estimates from the navigation engine and a first one of the smoothed estimates; and publishing, at a second point in time, later than the first point in time, in the transition-to-on interval, a second weighted average, of a second one of the estimates from the navigation engine and a second one of the smoothed estimates, the proportion of the smoothed estimate in the second weighted average being less than the proportion of the smoothed estimate in the first weighted average.

According to an embodiment of the present disclosure, there is provided a Global Navigation Satellite System receiver, including: means for processing; and a memory storing instructions which, when executed by the means for processing, cause performance of: receiving a first estimate from a navigation engine of the Global Navigation Satellite System receiver; and processing the first estimate with a first Kalman smoother.

In some embodiments: the first estimate is a velocity estimate; and the instructions, when executed by the means for processing, further cause performance of: converting the first estimate from east north up coordinates to latitude longitude coordinates.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a Global Navigation Satellite System receiver and a plurality of satellites, in some embodiments;

FIG. 2 is a block diagram of a Global Navigation Satellite System receiver and a plurality of satellites, in some embodiments;

FIG. 3A is a flowchart of a method, in some embodiments;

FIG. 3B is a flowchart of a method, in some embodiments;

FIG. 3C is a flowchart of a method, in some embodiments; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

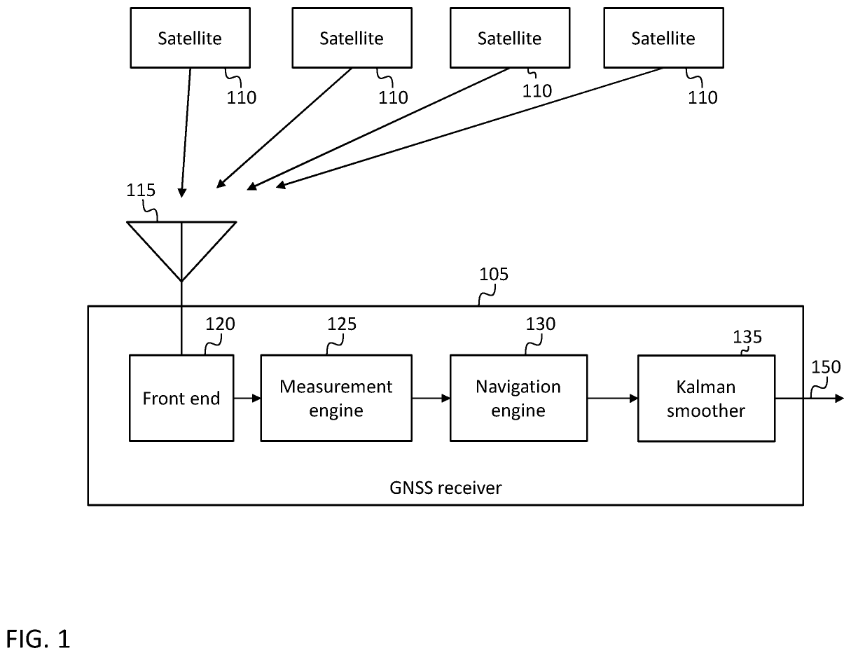

FIG. 1 shows a Global Navigation Satellite System receiver 105, and a plurality of Global Navigation Satellite System satellites 110, in some embodiments. Each satellite includes a high-accuracy clock, and transmits a signal to the Global Navigation Satellite System receiver. The Global Navigation Satellite System receiver 105 then infers the position of the Global Navigation Satellite System receiver 105 based on the measured time of flight from each satellite 110 and the position of each satellite. The Global Navigation Satellite System receiver 105 may also measure the frequency shift of the signal (due to the Doppler effect) and estimate, based on the measured frequency shift, the velocity of the Global Navigation Satellite System receiver 105.

The Global Navigation Satellite System receiver 105 may include an antenna 115 for receiving the signals from the satellites 110, a front end 120, a measurement engine 125, and a navigation engine 130. The measurement engine 125 may generate a pseudo range to each satellite, each pseudo range being a mapping from time of flight to range plus clock bias of receiver clock with respect to GPS time converted to units of distance by multiplying by speed of light. The measurement engine 125 may generate delta pseudo ranges, each corresponding to a rate of change of a pseudo range. The navigation engine 130 may include an estimator for generating estimates of position, velocity, and time. The estimates of position may be made in latitude-longitude-altitude (LLA) and velocity may be made in a North-East-Down (NED) coordinate frame or in an East-North-Up (ENU) coordinate frame.

The output of the navigation engine 130 may on occasion exhibit spec-outs or other indications of poor smoothness which may result in an unfavorable user experience. The smoothness of such data may be improved by a suitable filter, e.g., a Kalman filter, or a Kalman smoother. In some applications, the performance of a Global Navigation Satellite System receiver 105 on a two-dimensional (2D) trajectory, generally parallel to the local surface of the earth, is of primary importance, with the performance of the Global Navigation Satellite System receiver in altitude being of secondary importance or disregarded altogether. Moreover, the performance of Global Navigation Satellite System receiver at estimating time may also be of secondary importance.

A Kalman filter may be used to improve the smoothness of the estimates generated by the navigation engine 130. The Kalman filter state may be given by

x(k)=[x₁(k), x₂(k), v₁(k)v₂(k)]^{T} (1)

where a constant and orthogonal reference frame for the 1 and 2 directions as in the subscripts is assumed, and k is a discrete time index. For simplicity it may be assumed that the Global Navigation Satellite System receiver 105 operates in a small geographical region where the North-East-Down (NED) frame can be assumed to be constant, and dimension 1 may be taken to be North and dimension 2 may be taken to be East. In practice, further coordinate changes may be made to go back and forth between an LLA coordinate frame and NED in each Kalman filter update.

The dynamical model for a Kalman filter may be given by

xₖ₊₁=ϕₖxₖ+ₖ (2)

where the subscript k indicates discrete time, wₖ is assumed independent and identically distributed (i.i.d.) Gaussian random process over time with zero mean and covariance matrix Q (which may be non-diagonal).

The transition matrix ϕₖ is given by

$${ϕ}_{k} = [ \begin{matrix}1 & 0 & {t}_{k + 1} - {t}_{k} & 0 \\ 0 & 1 & 0 & {t}_{k + 1} - {t}_{k} \\ 0 & 0 & 1 & 0 \\ 0 & 0 & 0 & 1\end{matrix} ] \qquad ( 3 )$$

where tₖ is the time of the navigation engine's PVT solution at discrete update time k of the Kalman filter.

The measurement model is given by,

zₖ=Hₖxₖ+vₖ (4)

where zₖ is a 4-dimensional real vector containing the horizontal position and velocity solutions of the navigation engine 130, which are assumed to be noisy. Hₖ=I, and vₖ (which is the measurement noise) may be assumed independent and identically distributed (i.i.d.) Gaussian random process over time with zero mean and diagonal covariance matrix R.

The Kalman filter update equations may then be generated from the dynamical and measurement models.

At step k the algorithm uses prior estimates \hat{x}ₖ⁻ and its error covariance Pₖ⁻ (or initialization values for k=0) to compute the Kalman gain,

Kₖ=Pₖ⁻Hₖ^{T}(HₖPₖ⁻Hₖ^{T}+Rₖ)⁻¹ (5)

which is used to update the state with the measurements zₖ obtained at time k,

\hat{x}ₖ=\hat{x}ₖ⁻+Kₖ(zₖ−Hₖ\hat{x}ₖ⁻). (6)

Then the error covariance for the state vector is updated,

Pₖ=(I−KₖHₖ)Pₖ⁻, (7)

and finally, the filter projects ahead to produce the estimates that will be needed in the next iteration,

\hat{x}ₖ₊₁⁻=φₖ\hat{x}ₖ

Pₖ₊₁⁻=ϕₖPₖϕₖ^{T}+Qₖ. (8)

A 4-dimensional state vector has been used for ease of presentation, but due to the special form of H and 4), the Kalman filter may be decomposed into two parallel 2-dimensional Kalman filters. As a result, the matrix inversion required in the Kalman gain computation can be decomposed into two 2×2 matrix inversions.

A Kalman filter as disclosed above may have certain advantages over other filtering approaches. First, it fully uses the velocity information produced by the navigation engine. Second, at least under some assumptions and some performance metrics, it can be shown to be optimal. Furthermore, the required R and Q parameters are related to measurable quantities, and as such the tuning effort may be reduced by computing these statistics with training data for the given application. The Kalman filter, however has no explicit control over the smoothing lag (or delay), so that smoothing lag is not easily traded off against better (cross-track) positioning performance.

As such, in some embodiments, the Global Navigation Satellite System receiver 105 may include a Kalman smoother 135, which smooths the estimates generated by the navigation engine 130 and publishes (e.g., produces, at the output 150 of the Global Navigation Satellite System receiver 105) the smoothed estimates corresponding to a past (or present) time epoch. This smoothing operation (the processing of estimates generated by the navigation engine 130) transforms the raw estimates generated by the navigation engine 130 into smoothed estimates. The Kalman smoother 135 may be, or be part of, or be implemented in, a processing circuit (e.g., in one or more processors and a memory operatively coupled to the one or more processors). A controlled smoothing delay d may be introduced via such a Kalman smoother 135. The smoothing delay may be acceptable, especially in situations in which the Global Navigation Satellite System receiver is moving at relatively low velocity. A Kalman filter uses measurements from time [0, . . . , k] to produce an estimate of the state at time k. A fixed delay Kalman smoother 135 with smoothing delay d uses measurements from time [0, . . . , k] to produce an estimate of the state at time k−d.

A fixed delay Kalman smoother can be implemented, in one embodiment, by defining a super state vector as follows:

$$X ( k ) = [ \begin{matrix}\begin{matrix}\begin{matrix}x ( k ) \\ x ( k - 1 )\end{matrix} \\ ⋮\end{matrix} \\ x ( k - d )\end{matrix} ] \qquad ( 9 )$$

which leads to an extended dynamical equation,

$$X ( k + 1 ) = [ \begin{matrix}\begin{matrix}\begin{matrix}x ( k + 1 ) \\ x ( k )\end{matrix} \\ ⋮\end{matrix} \\ x ( k - d + 1 )\end{matrix} ] = [ \begin{matrix}ϕ & 0 & … & 0 & 0 \\ 1 & 0 & … & 0 & 0 \\ 0 & 1 & … & 0 & 0 \\ 0 & 0 & ⋱ & 0 & 0 \\ 0 & 0 & … & 1 & 0\end{matrix} ] [ \begin{matrix}\begin{matrix}\begin{matrix}x ( k ) \\ x ( k - 1 )\end{matrix} \\ ⋮\end{matrix} \\ x ( k - d )\end{matrix} ] + [ \begin{matrix}w ( k ) \\ 0 \\ ⋮ \\ 0\end{matrix} ] = Φ ( k ) X ( k ) + W ( k ) . \qquad ( 10 )$$

The covariance matrix of W(k) is given by

$$Q ( k ) = E [ W ( k ) {W}^{T} ( k ) ] = [ \begin{matrix}Q ( k ) & 0 & … & 0 \\ 0 & 0 & … & 0 \\ ⋮ & ⋮ & ⋱ & ⋮ \\ 0 & 0 & … & 0\end{matrix} ] . \qquad ( 11 )$$

The measurements only have a direct connection to the first element of X(k) so the

measurement equation for the super filter is

$$z ( k ) = [ 10 … 0 ] [ \begin{matrix}\begin{matrix}\begin{matrix}x ( k ) \\ x ( k - 1 )\end{matrix} \\ ⋮\end{matrix} \\ x ( k - d )\end{matrix} ] + v ( k ) = H ( k ) X ( k ) + v ( k ) \qquad ( 12 )$$

with the covariance matrix of v(k) being the same as in the original Kalman filter,

R(k)=E[v(k)*v^{T}(k)]r(k). (13)

With these definitions, the Kalman filter algorithm can be run on the superstate vector, and the d-delay smoother estimate directly read from the last entry or entries of the super state vector.

The matrix inversion used in the Kalman gain computation has the same dimension as R(k), which in the present case is a 4×4 matrix. As mentioned above, the complexity can be further reduced by separating the North and East components and running parallel Kalman smoothers.

Several features may be included in a Global Navigation Satellite System receiver with a Kalman smoother 135. The Kalman smoother 135 may be implemented using Latitude-Longitude-Altitude (LLA) coordinates. Such coordinates work globally and do not suffer from the approximation errors incurred in East-North-Up (ENU) or North-East-Down (NED) when the latter are used with the assumption that motion is in a plane tangential to the surface of the earth. To use LLA coordinates, the navigation engine's velocity solution may be converted (e.g., transformed) from NED or ENU to LLA rates. The Kalman smoother covariance matrices R and Q may be converted to angular units (e.g., may be converted to LLA coordinates) so that they will work globally and be expressed in the units used in the Kalman smoother 135. For example, each of the covariance matrices may be calculated based on a covariance matrix in, e.g., NED or ENU coordinates, and based on an estimated latitude of the Global Navigation Satellite System receiver 105. This conversion transforms the covariance matrices from one coordinate system (e.g., NED or ENU) into another (e.g., into angular units in LLA coordinates). As mentioned above, the Kalman smoother 135 may be decomposed into two separate Kalman smoothers operating independently across the latitude and longitude directions. This may reduce the complexity of the implementation. The enlarged matrix form of the Kalman smoother 135 described above uses large sparse matrices. In some embodiments, an alternative formulation is used for the Kalman smoother 135, based on the Rauch-Tung-Striebel (RTS) algorithm that uses the Kalman filter state variables without enlarging the state space. Intermediate results are saved, but storage and computation is more efficient unless the enlarged state space implementation exploits matrix sparsity.

It may be seen that when the delay is set to zero, the Kalman smoother 135 is the same filter as the Kalman filter disclosed above; as such, a Kalman filter is considered a special case of a Kalman smoother 135, as the term “Kalman smoother” is used herein.

At startup, the Kalman smoother 135 may take some time to converge. Moreover, even after the Kalman smoother 135 has converged, there may be a significant difference between each estimate generated by the navigation engine 130 and the concurrently generated smoothed output of the Kalman smoother 135. Such a difference may result, for example, from motion (e.g., at constant velocity) of the Global Navigation Satellite System receiver 105.

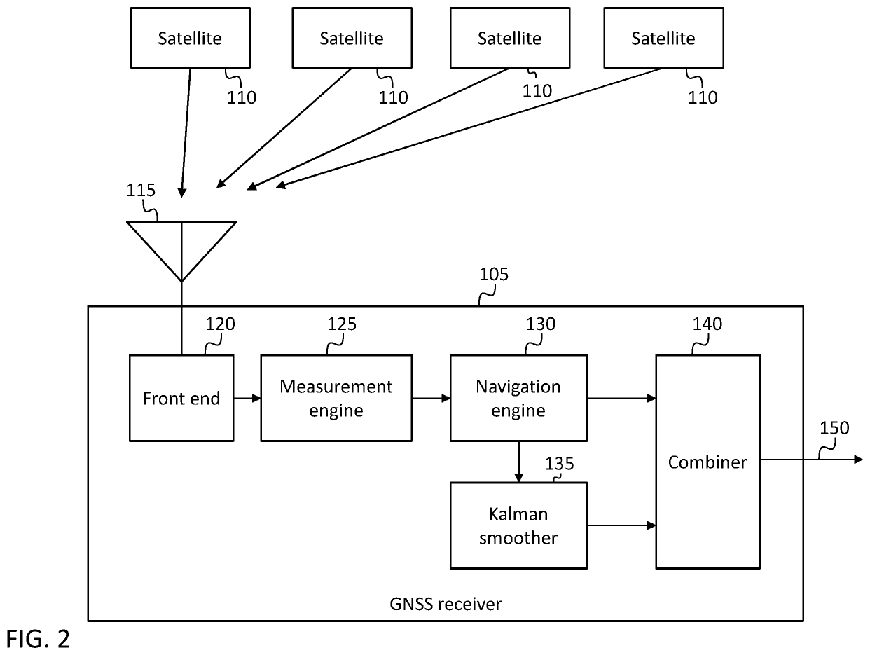

As such, referring to FIG. 2, some embodiments include a combiner 140 that receives both the estimates generated by the navigation engine 130 and the smoothed estimates generated by the Kalman smoother 135 and combines them in a manner that (i) avoids erroneous estimates at startup, before the Kalman smoother 135 has converged, and (ii) avoids discontinuities in the published output (at the output 150 of the Global Navigation Satellite System receiver 105). The combiner 140 may be, or be part of, or be implemented in, a processing circuit (e.g., in one or more processors and a memory operatively coupled to the one or more processors).

During a warmup period after startup, the combiner may publish only the estimates of the navigation engine 130, and the Kalman smoother 135 may run without its output being used as part of the published output of the Global Navigation Satellite System receiver. Once steady state is reached (e.g., once the Kalman smoother 135 has converged) the combiner 140 may gradually transition, during a transition-to-on interval, to publishing the output of the Kalman smoother 135. For example, the output of the combiner 140 may be a weighted sum of estimates of the navigation engine 130 and the smoothed output of the Kalman smoother 135, and the weights used in this weighted sum may be gradually changed from (i) an initial set of weights (used at the beginning of the transition-to-on interval) in which the weight given the output of the Kalman smoother 135 is zero, through (ii) a set of transitional weights in which the proportion, in the weighted average, of the smoothed estimate (the proportion of the smoothed output of the Kalman smoother 135) increases continuously, to (iii) a final set of weights, used in a state referred to as the “on” state, in which the weight given the estimates of the navigation engine 130 is zero. This final set of weights may be used during an “on” interval, during which the combiner 140 is in an “on” state.

Similarly, in some circumstances it may be appropriate to disable the Kalman smoother 135 (i.e., to operate in an “off” state, in which the Global Navigation Satellite System receiver 105 publishes only the estimates of the navigation engine 130). This may be the case, for example, if a user of the Global Navigation Satellite System receiver 105 transitions from a pedestrian mode, in which velocities are low, to a driving mode, in which (i) velocities may be high (causing the delay of the Kalman smoother 135 to result in large position errors) and (ii) significant delays in the reporting of the position may be unacceptable (because, for example, they may cause the user to be instructed too late to make a turn at an intersection). As another example, when the navigation engine 130 is in outage (e.g., when signals from too few satellites are being received), the Kalman smoother 135 may also be disabled. In some embodiments, to avoid disabling the Kalman smoother 135 for short outages of the navigation engine 130, the Global Navigation Satellite System receiver 105 keeps track of how many valid navigation epochs there are in a given time window, and stops the Kalman smoother 135 when that number falls below a threshold.

When transitioning to the off state, a similar gradual transition between publishing the output of the Kalman smoother 135 and publishing the estimates of the navigation engine 130 may be made. For example, the weights of the weighted sum may be changed gradually (i) from a set of on-state weights in which the weight given the estimates of the navigation engine 130 is zero, through (ii) a set of transitional weights in which the proportion, in the weighted average, of the smoothed estimate (the proportion of the smoothed output of the Kalman smoother 135) decreases continuously, to (iii) a set of off-state weights, in which the weight given the output of the Kalman smoother 135 is zero.

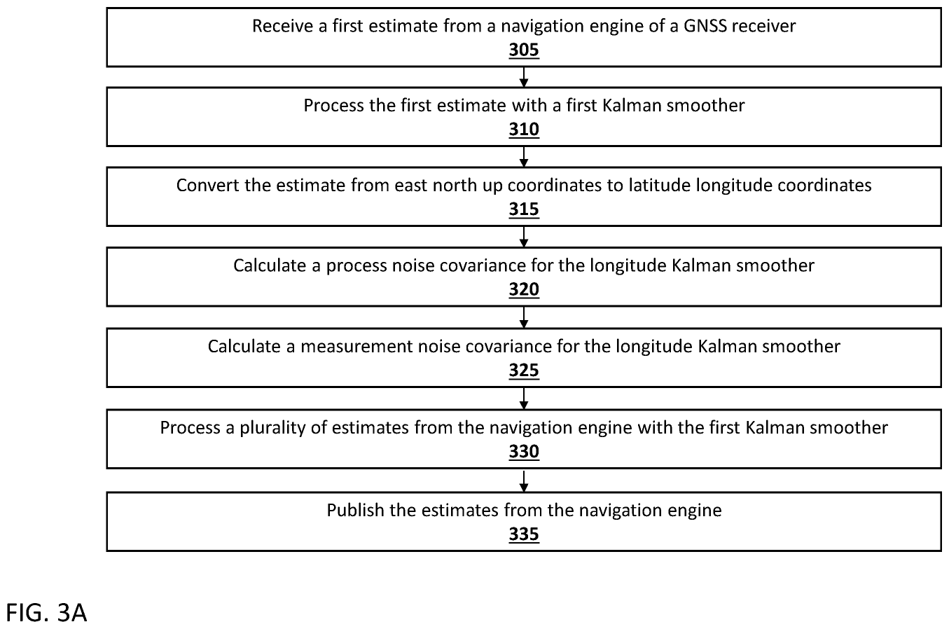

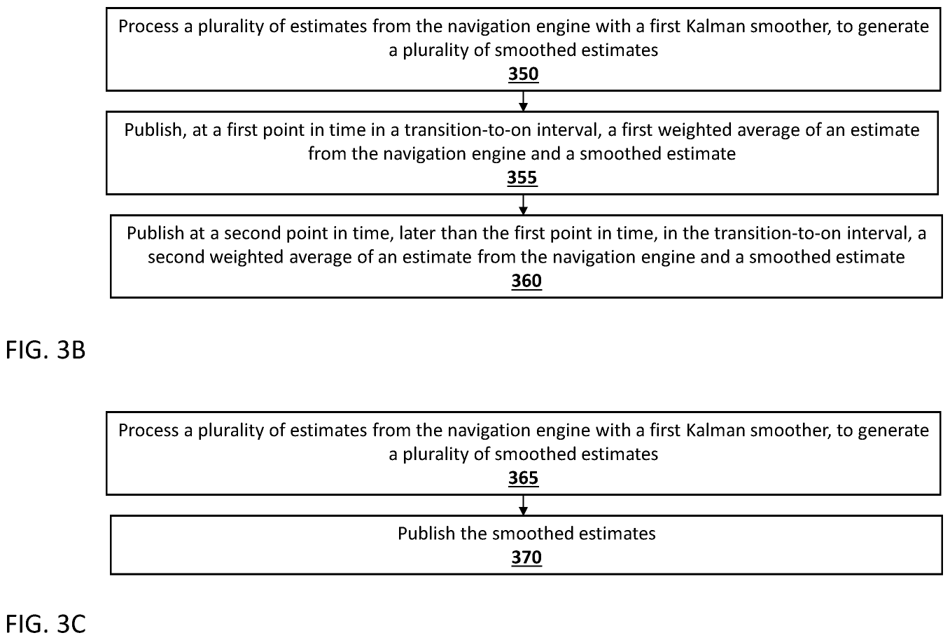

FIG. 3A is a flow chart of a method, in some embodiments. The method includes receiving, at 305, a first estimate from a navigation engine of a Global Navigation Satellite System (GNSS) receiver; processing, at 310, the first estimate with a first Kalman smoother, converting, at 315, the estimate from northeast-down or east north up coordinates to latitude longitude coordinates (such a conversion transforms the estimate from one coordinate system into another); calculating, at 320, a process noise covariance for the longitude Kalman smoother, based on an estimated latitude; calculating, at 325, a measurement noise covariance for the longitude Kalman smoother, based on an estimated latitude; processing, at 330, a plurality of estimates from the navigation engine, including the first estimate, with the first Kalman smoother; and publishing, at 335, the estimates from the navigation engine.

FIG. 3B is a flow chart of a method, in some embodiments. The method includes processing, at 350, a plurality of estimates from the navigation engine with the first Kalman smoother, to generate a plurality of smoothed estimates; publishing, at 355, at a first point in time in the transition-to-on interval, a first weighted average of an estimate from the navigation engine and a smoothed estimate; and publishing, at 360, at a second point in time, later than the first point in time, in the transition-to-on interval, a second weighted average of an estimate from the navigation engine and a smoothed estimate. In the method of FIG. 3B, the proportion of the smoothed estimate in the second weighted average may be greater or less than the proportion of the smoothed estimate in the first weighted average. FIG. 3C is a flow chart of a method, in some embodiments. The method includes processing, at 365, a plurality of estimates from the navigation engine with the first Kalman smoother, to generate a plurality of smoothed estimates; and publishing, at 370, the smoothed estimates. In some embodiments, the Global Navigation Satellite System receiver 105, or a device (e.g., a mobile telephone, watch, tablet computer, or navigation system in an automobile) including the Global Navigation Satellite System receiver 105, may include or be connected to a display. In such an embodiment, the Global Navigation Satellite System receiver 105, or the device including the Global Navigation Satellite System receiver 105, may display the published estimates (e.g., on a map), or it may display information based on the published estimates (e.g., a street address near the Global Navigation Satellite System receiver 105, businesses or other establishments near the Global Navigation Satellite System receiver 105, or directions to an address or location).

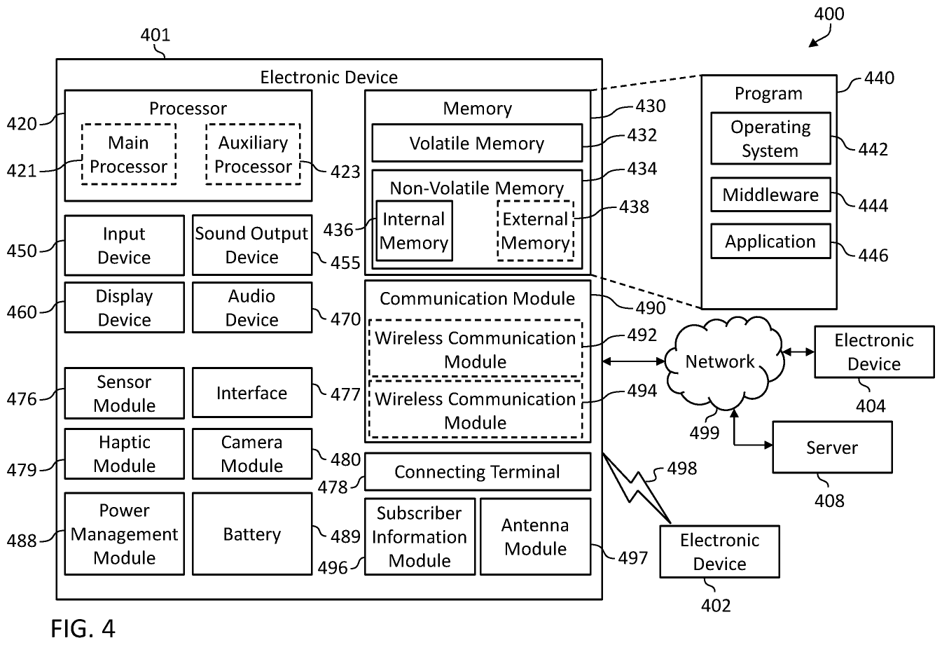

FIG. 4 is a block diagram of an electronic device in a network environment 400, according to an embodiment. In some embodiments, a Global Navigation Satellite System receiver 105 may include features of the electronic device of FIG. 4.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 440, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 446 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving a first estimate from a navigation engine of a Global Navigation Satellite System (GNSS) receiver; and
processing the first estimate with a first Kalman smoother.

2. The method of claim 1, wherein the first estimate is a position estimate.

3. The method of claim 2, wherein the first Kalman smoother comprises a latitude Kalman smoother and a longitude Kalman smoother.

4. The method of claim 3, further comprising calculating a process noise covariance for the longitude Kalman smoother, based on an estimated latitude.

5. The method of claim 3, further comprising calculating a measurement noise covariance for the longitude Kalman smoother, based on an estimated latitude.

6. The method of claim 1, further comprising, during a warmup interval:
processing a plurality of estimates from the navigation engine, including the first estimate, with the first Kalman smoother; and
publishing the estimates from the navigation engine.

7. The method of claim 1, further comprising, during a transition-to-on interval:
processing a plurality of estimates from the navigation engine with the first Kalman smoother, to generate a plurality of smoothed estimates;
publishing, at a first point in time in the transition-to-on interval, a first weighted average, of a first one of the estimates from the navigation engine and a first one of the smoothed estimates; and
publishing, at a second point in time, later than the first point in time, in the transition-to-on interval, a second weighted average, of a second one of the estimates from the navigation engine and a second one of the smoothed estimates,
the proportion of the smoothed estimate in the second weighted average being greater than the proportion of the smoothed estimate in the first weighted average.

8. The method of claim 1, further comprising, during an on interval:
processing a plurality of estimates from the navigation engine with the first Kalman smoother, to generate a plurality of smoothed estimates; and
publishing the smoothed estimates.

9. The method of claim 1, further comprising, during a transition-to-off interval:
processing a plurality of estimates from the navigation engine with the first Kalman smoother, to generate a plurality of smoothed estimates;
publishing, at a first point in time in the transition-to-on interval, a first weighted average, of a first one of the estimates from the navigation engine and a first one of the smoothed estimates; and
publishing, at a second point in time, later than the first point in time, in the transition-to-on interval, a second weighted average, of a second one of the estimates from the navigation engine and a second one of the smoothed estimates, the proportion of the smoothed estimate in the second weighted average being less than the proportion of the smoothed estimate in the first weighted average.

10. A Global Navigation Satellite System receiver, comprising:
one or more processors; and
a memory storing instructions which, when executed by the one or more processors, cause performance of:
receiving a first estimate from a navigation engine of the Global Navigation Satellite System receiver; and
processing the first estimate with a first Kalman smoother.

11. The Global Navigation Satellite System receiver of claim 10, wherein the first estimate is a position estimate.

12. The Global Navigation Satellite System receiver of claim 11, wherein the first Kalman smoother comprises a latitude Kalman smoother and a longitude Kalman smoother.

13. The Global Navigation Satellite System receiver of claim 12, wherein the instructions, when executed by the one or more processors, further cause performance of:
calculating a process noise covariance for the longitude Kalman smoother, based on an estimated latitude.

14. The Global Navigation Satellite System receiver of claim 12, wherein the instructions, when executed by the one or more processors, further cause performance of:
calculating a measurement noise covariance for the longitude Kalman smoother, based on an estimated latitude.

15. The Global Navigation Satellite System receiver of claim 10, wherein the instructions, when executed by the one or more processors, further cause performance, during a warmup interval, of:
processing a plurality of estimates from the navigation engine, including the first estimate, with the first Kalman smoother; and
publishing the estimates from the navigation engine.

16. The Global Navigation Satellite System receiver of claim 10, wherein the instructions, when executed by the one or more processors, further cause performance, during a transition-to-on interval, of:
processing a plurality of estimates from the navigation engine with the first Kalman smoother, to generate a plurality of smoothed estimates;
publishing, at a first point in time in the transition-to-on interval, a first weighted average, of a first one of the estimates from the navigation engine and a first one of the smoothed estimates; and
publishing, at a second point in time, later than the first point in time, in the transition-to-on interval, a second weighted average, of a second one of the estimates from the navigation engine and a second one of the smoothed estimates,
the proportion of the smoothed estimate in the second weighted average being greater than the proportion of the smoothed estimate in the first weighted average.

17. The Global Navigation Satellite System receiver of claim 10, wherein the instructions, when executed by the one or more processors, further cause performance, during an on interval, of:
processing a plurality of estimates from the navigation engine with the first Kalman smoother, to generate a plurality of smoothed estimates; and
publishing the smoothed estimates.

18. The Global Navigation Satellite System receiver of claim 10, wherein the instructions, when executed by the one or more processors, further cause performance, during a transition-to-off interval, of:
processing a plurality of estimates from the navigation engine with the first Kalman smoother, to generate a plurality of smoothed estimates;
publishing, at a first point in time in the transition-to-on interval, a first weighted average, of a first one of the estimates from the navigation engine and a first one of the smoothed estimates; and
publishing, at a second point in time, later than the first point in time, in the transition-to-on interval, a second weighted average, of a second one of the estimates from the navigation engine and a second one of the smoothed estimates,
the proportion of the smoothed estimate in the second weighted average being less than the proportion of the smoothed estimate in the first weighted average.

19. A Global Navigation Satellite System receiver, comprising:
means for processing; and
a memory storing instructions which, when executed by the means for processing, cause performance of:
receiving a first estimate from a navigation engine of the Global Navigation Satellite System receiver; and
processing the first estimate with a first Kalman smoother.

20. The Global Navigation Satellite System receiver of claim 19, wherein:
the first estimate is a velocity estimate; and
the instructions, when executed by the means for processing, further cause performance of:
converting the first estimate from east north up coordinates to latitude longitude coordinates.
